(19) United States
(12) Patent Application Publication
(10) Pub. No.: US 2026/0310654 A1
(43) Pub. Date: Oct. 8, 2026

(54) AUTOMATED FEATURE GENERATION FOR PREDICTIVE ANALYTICS WITH GENERATIVE ARTIFICIAL INTELLIGENCE

(71) Applicant: BEFOREPAY IP PTY LTD, Sydney (AU)

(72) Inventors: James Spencer TWISS, Sydney (AU); Kasey KAPLAN, Sydney (AU)

(21) Appl. No.: 19/638,118

(22) Filed: Apr. 3, 2026

Related U.S. Application Data
(60) Provisional application No. 63/782,820, filed on Apr. 3, 2025.

(51) Int. Cl. G06F 16/23; G06F 16/22; G06F 16/2455

(52) U.S. Cl. CPC G06F 16/2365; G06F 16/2246; G06F 16/2455

(57) ABSTRACT

A system for automated generation of features for a machine learning model obtains a machine-readable schema of a training dataset and generates candidate feature concepts by providing at least one first prompt, including at least one seed value not derived from the training dataset, to a first large language model operated at a first randomness setting. The system generates normalized feature specifications using a second large language model operated at a second randomness setting lower than the first randomness setting, and generates feature computation code using a third large language model fine-tuned on feature computation code. Prior to storage or execution, the system performs schema-aware validation by parsing the feature computation code into an abstract syntax tree, extracting identifier references, enforcing an identifier allowlist, verifying type rules, and rejecting prohibited constructs. Validated code is executed in a sandboxed execution environment enforcing runtime restrictions.

### FIELD OF THE INVENTION

The present disclosure relates to the field of artificial intelligence and machine learning, specifically to automated feature engineering for predictive analytics using generative large language models.

### BACKGROUND

In the rapidly evolving field of artificial intelligence and machine learning, developing predictive models is a task of significant importance that requires identifying and utilizing relevant features from large datasets. Traditionally, feature engineering has been a manual, labor-intensive process, often limited by the expertise and time available to data scientists. This manual approach restricts the pool of candidate features, potentially hindering the performance and accuracy of predictive models. As the demand for more sophisticated and accurate models increases, there is a pressing need for automated systems that can efficiently generate a vast array of features, thereby enhancing the predictive capabilities of machine learning models.

Existing solutions have attempted to address this need by partially automating the feature generation process. However, these systems often fall short in terms of scalability, creativity, and the ability to produce high-quality, executable code. They may rely on static configurations or limited data processing capabilities, which can result in a narrow scope of feature ideas and a lack of adaptability to different datasets and analytical contexts. As a result, there is a significant opportunity for innovation in creating a comprehensive, automated feature engineering system that can overcome these limitations and provide a more dynamic and reliable method for feature generation in predictive analytics.

### SUMMARY OF THE INVENTION

In one embodiment, the disclosure provides a system for automated generation of features for machine learning models. The system comprises a first large language model module configured with a high temperature and seeding techniques to generate a diverse set of feature ideas. A second large language model module, operating with a lower temperature setting, refines these diverse ideas into interpretable prompts while preserving a degree of randomness. In addition, a third, fine-tuned coding large language model module generates executable feature code based on a schema of training data and the refined prompts. The system further incorporates a feature orchestrator to manage, route, and retrieve outputs from the various modules, as well as a feature store for recording candidate features along with associated evaluative metrics.

In another embodiment, the system includes a code execution module that features a protective sandbox environment. This sandbox is configured to restrict the available instructions to those necessary for text matching, data-handling, and mathematical functions, while explicitly preventing the loading of additional libraries. A feature evaluation module is also provided, which assesses the predictive value of the generated features by executing a Kolmogorov-Smirnov test on a representative subset of the dataset. This evaluation enables the dynamic filtering and prioritization of features based on their predictive power.

In further embodiments, the system incorporates an iterative error handling and debugging process. If the generated feature code fails to execute, automated subroutines parse the error messages and apply corrections—for example, inserting safeguards to address division-by-zero scenarios. Complementary routines clean and format outputs from the large language models to ensure they are appropriately structured for subsequent processing steps, including conversion into programming language constructs such as formatted lists.

Additionally, the disclosure encompasses methods for generating synthetic features for hypothetical models when existing feature sets are unavailable. This process enables the system to inform subsequent training by producing lower quality, yet instructive, feature candidates that can be refined in iterative cycles. The described technology further includes automated routines for cleaning and formatting outputs from the large language models, thereby ensuring the data is consistently prepared for feature orchestration and integration within the overall predictive analytics framework.

Taken together, these embodiments provide a comprehensive, automated approach to feature engineering in predictive analytics. By leveraging generative artificial intelligence across multiple stages—from creative idea generation and prompt refinement to safe code execution and dynamic feature evaluation—the disclosed system significantly reduces the manual effort traditionally required in feature engineering, while enhancing the scalability, quality, and diversity of candidate features for machine learning applications.

### BRIEF DESCRIPTION OF THE FIGURES

FIG. 1 is a block diagram illustrating the architecture of the multi-stage generative

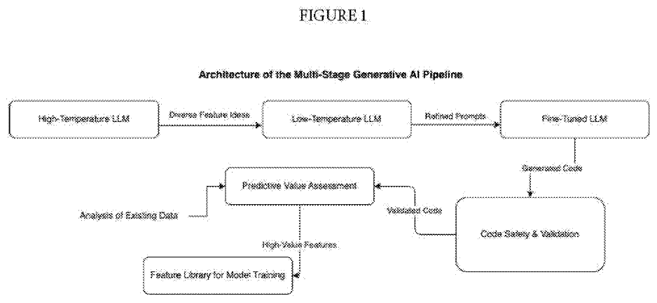

AI pipeline for automated feature generation.

FIG. 2 is a flow chart diagram illustrating the workflow for code safety validation in the automated feature generation system.

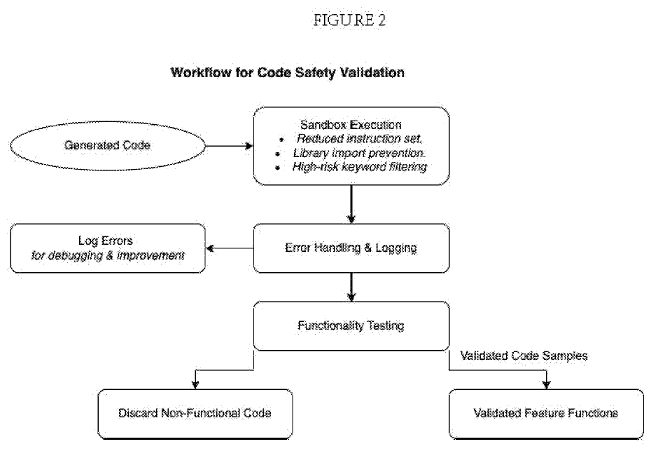

FIG. 3 is a flow chart diagram illustrating the KS-based filtering process for feature evaluation in predictive analytics.

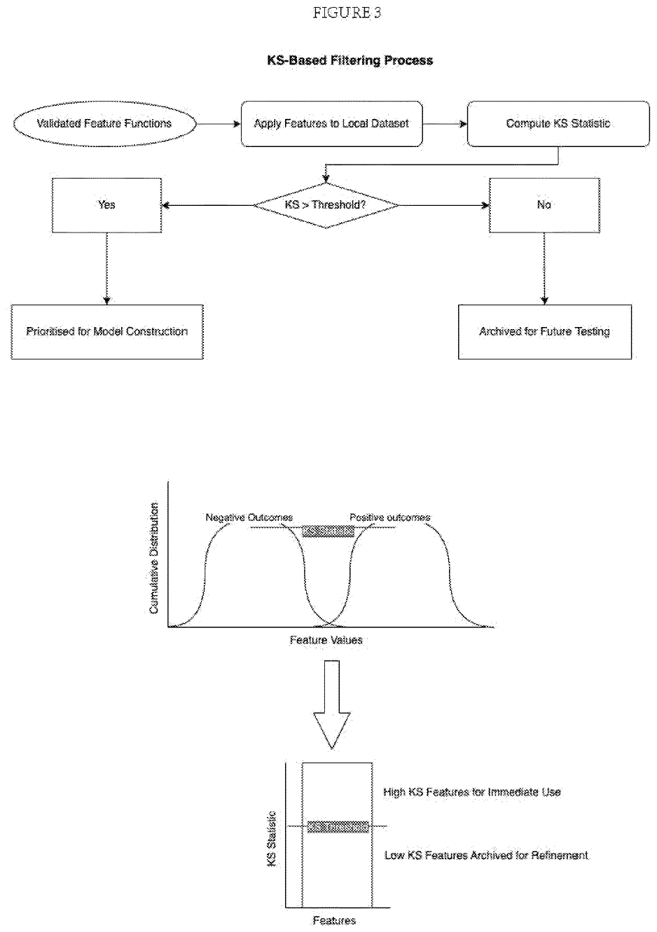

FIG. 4 is a block diagram illustrating the detailed interaction between the large language model (LLM) modules within the automated feature generation system. It shows the flow of data from the high-temperature LLM, which generates diverse feature ideas, to the low-temperature LLM, which refines these ideas into interpretable prompts, and finally to the fine-tuned coding LLM, which produces executable feature code. The diagram highlights the hierarchical structure and the transformation of ideas through each stage.

FIG. 5 is a diagram depicting the operations of the feature orchestrator and feature store within the system. It illustrates how the feature orchestrator manages the routing and retrieval of outputs from the LLM modules, ensuring seamless integration and storage of candidate features in the feature store. The figure also shows the association of evaluative metrics with each stored feature, facilitating efficient feature management and prioritization.

FIG. 6 is a flowchart detailing the iterative error handling and debugging process within the system. It outlines the steps taken when generated feature code fails to execute, including logging error messages, parsing errors, applying automated fixes, and re-executing the code. The flowchart also depicts the decision points for determining whether a feature can be corrected or should be archived as unfixable, ensuring robust error management and system reliability.

FIG. 7 is a diagram illustrating generation of a normalized feature specification from a candidate feature concept and use of the normalized feature specification together with a dataset schema to generate and validate feature computation code prior to sandbox execution.

FIG. 8 is a diagram illustrating validation of generated feature computation code using abstract syntax tree analysis, including parsing generated code into an abstract syntax tree, extracting identifiers, applying allowlist and type-consistency rules, and detecting prohibited constructs to produce a validation result.

FIG. 9 is a diagram illustrating records stored in a feature store for lifecycle tracking of generated features, including feature metadata, evaluation metrics, and lifecycle progression information associated with generated features.

FIG. 10 is a diagram illustrating a seed-based generation and output-cleaning workflow, including generation of seed values, production of raw model output at a higher randomness setting, cleaning and structuring of the output, validation of the structured output, and regeneration when validation fails.

### DESCRIPTION OF A PREFERRED EMBODIMENT

In order to build a predictive model with machine learning, it is necessary first to start with a large pool of candidate features, where a “feature” is a specific, defined, quantitative or scalar variable that can be calculated for the test data set. For example, in credit-risk modeling, a feature might be an applicant's income, or the frequency with which they withdraw cash from an ATM, or any other variable that can be calculated with the available data. Machine-learning algorithms are then used to select the most predictive features from this candidate pool and assemble them into a model.

Historically, these features have been defined and coded by hand, a labor-intensive process, which limits the pool of candidate features to several hundred. A technique to create thousands, or even tens of thousands, of features in a fully automated fashion, using generative AI in the form of a large language model (LLM) is described herein.

To do this, at least three separate LLMs with different settings and configurations across multiple stages are used in order to generate feature ideas that are highly creative and sufficiently varied (to reduce duplication), but highly controlled and conforming in how they express those ideas and code. This tension between creativity and control is a classic challenge in generative AI.

As used herein, a “seed” refers to a token, phrase, or other textual element supplied to a language model to stimulate variation in generated output. In some embodiments, a seed is selected to be non-domain-specific relative to the subject matter of the predictive model to be built, thereby increasing diversity in generated candidate feature concepts.

As used herein, a “candidate feature concept” refers to a natural-language description of a potential quantitative variable that may be computed from one or more fields of a dataset. A candidate feature concept may describe a relationship, pattern, or transformation without yet specifying an exact computational implementation.

As used herein, a “normalized feature specification” refers to a structured representation of a candidate feature concept expressed in a predefined format containing explicit fields. In some embodiments, the normalized feature specification includes at least a feature name, one or more referenced columns, an operation definition, and an output data type, and may optionally include a prescribed function signature.

As used herein, a “schema” refers to a machine-readable description of the structure of a dataset, including at least column identifiers and corresponding data types. In various embodiments, the schema may be represented as a JSON object, SQL data definition language, Apache Arrow schema, dataframe metadata, or another machine-readable schema representation.

As used herein, a “schema-consistency check” refers to an automated validation procedure that verifies that generated feature computation code conforms to the schema. Such validation may include verifying that referenced columns exist, verifying that operations are compatible with corresponding data types, and verifying conformance to a predefined function interface.

As used herein, “feature computation code” refers to executable code that implements a feature computation function. In some embodiments, the feature computation code is Python code that accepts a single input record and returns a scalar feature value. In other embodiments, the feature computation code may comprise a SQL expression, a user-defined function, or another executable representation.

As used herein, a “randomness setting” or “temperature” refers to a configurable parameter that affects variation in language model output. In some embodiments, a first language model used for generation of candidate feature concepts operates at a temperature between approximately 0.8 and 1.0, while a second language model used for normalization operates at a lower temperature between approximately 0.2 and 0.6.

In one embodiment, the first LLM 101 operates at a comparatively high temperature, for example between approximately 0.8 and 1.0, to increase diversity of candidate feature concepts. In some embodiments, one or more seed values are included in a prompt as standalone tokens, phrases, or short textual instructions to stimulate divergent generation. This can generate a highly diverse set of ideas 103, although the resulting output may require downstream normalization and validation before use in feature computation code generation. By way of example, a prompt may instruct the first LLM 101 to consider a topic, person, field, or concept and to generate multiple candidate feature ideas based on that prompt. A skilled person will appreciate that many other prompting strategies may be used to generate diverse candidate feature concepts.

A second large language model is configured to operate at a lower randomness setting than the first large language model to convert candidate feature concepts into a structured output suitable for automated processing. For example, the second large language model may be invoked with a temperature between approximately 0.2 and 0.6 to produce more repeatable normalized feature specifications while retaining enough variation to avoid excessive duplication. In some embodiments, the second large language model is fine-tuned on natural-language feature descriptions, normalized feature specifications, or pairs thereof to improve generation of structured outputs. In one embodiment, the second LLM is instructed to ingest the ideas generated by the first LLM 101 and to create a structured output in plain language or another predefined format. For example, the output may comprise a list, table, JSON object, or other machine-readable representation of the generated feature ideas.

The third large language model 109 is provided with the schema of the training data and the normalized feature specification derived from the candidate feature concept to generate feature computation code 117. In some embodiments, the third large language model is configured to accept, as input, the machine-readable schema and the normalized feature specification, and to generate feature computation code conforming to a prescribed function interface. The third large language model may be fine-tuned on feature computation code, including code examples that implement feature computation functions from normalized feature specifications. In some embodiments, the output of the second LLM 105 is converted into a normalized feature specification having a predefined structure suitable for automated processing. The normalized feature specification may include fields such as feature_name, referenced_columns, operations, output_type, and, in some embodiments, an optional function_signature field.

In some embodiments, the second large language model and the third large language model are fine-tuned using datasets comprising pairs of natural-language feature descriptions and corresponding code implementations, collections of validated feature computation functions, and rejected or corrected feature examples used as negative training examples. Training data may be curated to remove invalid or unsafe code and may further include metadata identifying schema usage and prescribed function signatures.

Fine-tuning objectives may include improving syntactic correctness of generated code, increasing adherence to schema constraints, reducing generation of prohibited operations, and improving execution success rates. Model performance may be evaluated using one or more metrics including code validity, execution success rate, and predictive performance of generated features.

In some embodiments, one or more of the first, second, and third large language model stages are implemented using different foundation models. In other embodiments, two or more stages are implemented using a common underlying model invoked with different prompts, temperatures, or reasoning settings, optionally with conversational memory cleared between calls to reduce cross-stage contamination.

The schema provided to the third LLM 109 may be supplied in any machine-readable format sufficient to identify available data fields and associated types, including JSON, SQL data definition language, Apache Arrow schema definitions, or dataframe metadata. The third LLM 109 is prompted using both the schema and the normalized feature specification so that generated feature computation code is constrained to reference permitted fields and produce an output consistent with the specified output type.

In some embodiments, the feature computation code generated by the third LLM 109 conforms to a prescribed function interface. By way of example, the prescribed function interface may define a function that accepts a single input record and returns a single scalar feature value having a data type corresponding to the output_type field of the normalized feature specification.

In some embodiments, transformation from a candidate feature concept to a normalized feature specification is performed by applying a predefined output schema to language model output so that each resulting specification contains explicit fields required for code generation and validation.

The normalized feature specification and the dataset schema together define the permissible scope of generated feature computation code prior to validation and execution.

In some embodiments, the normalized feature specification acts as an execution-environment-independent intermediate representation that can be supplied to different code generation backends. Accordingly, feature computation logic may be generated or translated into Python functions, SQL expressions executed within a data warehouse, user-defined functions in distributed processing frameworks, warehouse-native user-defined functions, transformation pipelines, streaming feature computations operating on event data, or application programming interface-based feature services configured to compute features on demand.

In embodiments involving multi-record or multi-table feature computations, the normalized feature specification may further include one or more of a window definition, a grouping field, a lookback period, or a join condition. Such fields enable generation of feature computation logic for rolling averages, grouped aggregations, event-based features, and joins across multiple tables.

By way of example, a machine-readable schema may be represented as a structured payload such as: {“customer_id”: “string”, “monthly_income”: “float”, “cash_withdrawal_count_30d”: “integer”, “cash_withdrawal_amount_30d”: “float”, “account_open_date”: “date”, “default_flag”: “integer”}. In one embodiment, a prescribed function interface corresponding to such a schema comprises a function definition of the form def compute_feature(record):, where record contains values associated with the named schema fields and the function returns a single scalar feature value.

In some embodiments, the system uses a multi-stage language model pipeline in which a first language model generates diverse candidate feature concepts, a second language model normalizes the concepts into structured specifications, and a third language model generates feature computation code from the specifications and the dataset schema. Once this is complete, the next step is to ensure that the code is safe to execute in a fully automated way. In some embodiments, execution is performed in a a protected sandbox environment (2) is of course helpful; in addition, the instruction set available to the code is reduced back to the specific instructions that are expected to be required, primarily, text matching, data-handling, and mathematical functions. In some embodiments, safety validation is performed by analyzing the generated code using an abstract syntax tree to detect prohibited constructs and to enforce identifier allowlists and type rules. In some embodiments, keyword-based screening is additionally applied as a supplemental check, but is not relied upon as the sole mechanism for preventing prohibited constructs.

In some embodiments, safety validation of generated feature computation code includes parsing the code into an abstract syntax tree prior to execution. The abstract syntax tree provides a structured representation of the code that enables deterministic inspection of identifiers, operations, and prohibited constructs.

After parsing, the system extracts identifier references from the abstract syntax tree. The extracted identifiers may include referenced column names, variable identifiers, function calls, and attribute accesses.

The extracted identifiers are compared against an allowlist. In some embodiments, the allowlist includes at least column names present in the schema, variables defined locally within the generated code, and functions contained in a predefined allowlist of permitted built-in operations.

The validation process may further apply one or more type rules derived from the schema. By way of example, arithmetic operations may be permitted only on numeric columns, date arithmetic may be permitted only on date or timestamp columns, and text operations may be permitted only on string columns.

The abstract syntax tree may also be scanned for prohibited constructs, including import statements, dynamic code execution instructions, file system access instructions, and network communication instructions. If a prohibited construct is detected, the generated code is rejected or routed to a repair or regeneration workflow.

The result of the validation process may include a validation status and one or more reason codes identifying whether validation failed due to a schema mismatch, a type-rule violation, a prohibited construct, or another validation condition.

The code may be tested for functionality by executing the feature computation function on one or more test records in the sandboxed execution environment to confirm successful execution within one or more enforced resource limits. Code that fails validation or execution may be stored with associated error information and routed to repair, regeneration, or archival. Code that executes successfully may be stored as validated feature computation code in a repository or library of feature functions for later retrieval and use during downstream model training or deployment. In some embodiments, predictive value of a generated feature is evaluated before downstream model training using a labeled sample dataset. This pre-training evaluation is optional. In some implementations, predictive evaluation is deferred until downstream model construction because some features may provide limited standalone predictive value but still improve model performance when combined with other features. In other implementations, pre-training evaluation is used to reduce computational cost by filtering, ranking, or deprioritizing candidate features before more expensive model-training workflows are performed.

In one optional embodiment, predictive value of a generated feature is evaluated using a Kolmogorov-Smirnov statistic computed on a subset of records from a training dataset. For example, approximately 500 to 2000 labeled records may be selected, each record having an associated target label. The generated feature computation function is applied to the selected records to compute feature values, and cumulative distributions of the feature values are determined separately for different label groups. The Kolmogorov-Smirnov statistic may then be computed as the maximum absolute difference between the respective cumulative distributions.

The resulting score may be compared with a threshold to determine whether the feature is retained for further testing, removed, stored separately, or prioritized relative to other candidate features. Although a Kolmogorov-Smirnov statistic is one suitable evaluation metric, other embodiments may additionally or alternatively employ information value, a Gini coefficient, area under a receiver operating characteristic curve, mutual information, correlation-based measures, or other predictive-value metrics. In some embodiments, predictive evaluation is omitted at this stage and candidate features are instead evaluated during downstream model training.

The results of this test call are run through a system to clean the results and ensure that they are formatted in such a way that they can proceed to the next step in a fully automated way. For example, if the LLM system is built in Python, it is essential to ensure that the output of step 1 is a formatted Python list that can be passed to step 3. This system has three parts; first, a set of cleaning commands that identify and remove (or convert) common issues (such as explanatory text at the beginning of an LLM response), second, string manipulations to ensure the result is an object of the right type (such as a list of ten strings), and third, a test to check whether the next step will execute successfully or not. If the payload will execute successfully, it is passed to step 3; if it fails, it is written to an error file which is reviewed periodically to improve the cleaning code, and then the system resets and returns to step 1.

In some embodiments, output from one or more language model stages is processed by a cleaning module configured to remove extraneous content, normalize formatting, and convert the output into a predefined structured representation suitable for automated downstream processing. The cleaning module may further apply a structural validity check for the next stage and, when the check fails, log the output and trigger regeneration using a new seed value, a modified prompt, or a repeated call to the same language model. Raw output from the language model may be passed to a cleaning module configured to remove explanatory text, convert malformed content into a structured representation, and normalize the output into a list, JSON object, or other machine-readable format suitable for downstream processing.

A validation check may be applied to the cleaned output to determine whether the output satisfies a structural requirement for the next stage. If the output fails validation, the output may be logged and the generation process may be repeated with a new seed value, a modified prompt, or a repeated call to the same model.

An illustrative example of the disclosed workflow will now be described. Consider a training dataset having a schema including customer_id of type string, monthly_income of type float, cash_withdrawal_count_30d of type integer, cash_withdrawal_amount_30d of type float, account_open_date of type date, and default_flag of type integer.

A seed value supplied to the first LLM 101 may be “Vienna classical composer.” In response to a prompt including that seed value, the first LLM 101 may generate a candidate feature concept such as: customers who frequently withdraw small amounts of cash over many days may exhibit financial stress patterns.

The second LLM 105 may convert that candidate feature concept into a normalized feature specification including a feature name of cash_withdrawal_intensity, referenced columns of cash_withdrawal_count_30d and cash_withdrawal_amount_30d, an operation definition corresponding to average withdrawal size over a recent time period, and an output type of float.

In some embodiments, the normalized feature specification further includes a prescribed function signature, for example a function definition that accepts a single record argument. The normalized feature specification is then supplied together with the schema to the third LLM 109.

In response, the third LLM 109 may generate feature computation code that reads the referenced columns from an input record, checks whether the withdrawal count equals zero, returns a default value of 0.0 if the count equals zero, and otherwise computes a ratio of withdrawal amount to withdrawal count.

The validation pipeline may then confirm that the referenced columns exist in the schema, confirm that numeric operations are applied to numeric columns, confirm that the generated code contains no prohibited constructs, and confirm that the function executes successfully in a sandboxed execution environment on one or more test records.

If validation succeeds, the feature may proceed to predictive evaluation and storage. If validation fails, the code may be rejected, repaired, or regenerated.

A further illustrative example concerns a date-based feature. In one embodiment, the normalized feature specification includes a feature_name of days_since_account_open, referenced_columns including account_open_date, an operation corresponding to current_date minus account_open_date, and an output_type of integer.

In response to such a specification, generated feature computation code may obtain an account_open_date value from an input record, determine whether the value is null or otherwise unavailable, return a default value when the account_open_date value is unavailable, and otherwise compute an elapsed number of days between a current date and the account_open_date value.

A further illustrative example concerns a text-based feature. In one embodiment, the normalized feature specification includes a feature_name of contains_gambling_keyword, referenced_columns including transaction_description, an operation corresponding to testing whether the text contains one or more predefined keywords, and an output_type of boolean.

In response to such a specification, generated feature computation code may obtain a transaction_description value from an input record, replace a missing text value with a default empty string, normalize the text to a common case, and determine whether the normalized text contains one or more keywords associated with a target pattern.

The generated feature computation code is cleaned and tested for safe and successful execution. In some embodiments, the code is validated prior to execution using abstract syntax tree analysis to detect prohibited constructs and to enforce identifier allowlists and type-consistency rules derived from the schema. In some embodiments, keyword-based screening is additionally applied as a supplemental check, for example to flag suspicious tokens or patterns, but is not relied upon as the sole mechanism for preventing prohibited operations. After validation, the code is executed in a sandboxed execution environment with access to sample data and with runtime restrictions configured to prevent unauthorized system interaction. In some embodiments, the sandbox environment is implemented using one or more technical isolation mechanisms including containerized execution environments, virtual machine isolation, restricted language runtimes, or operating system syscall filtering.

The sandbox environment may disable file system access, disable external network communication, restrict available built-in functions to a predefined allowlist, and disable dynamic code evaluation instructions. In some embodiments, import resolution is disabled at runtime so that generated code cannot load external libraries during execution.

The sandbox environment may further enforce computational limits including a maximum execution time, a memory usage limit, and a maximum recursion depth. By way of example, an execution time limit may be in a range of approximately 50 to 500 milliseconds per feature function, and a memory limit may be in a range of approximately 32 to 256 megabytes per execution.

These execution constraints enable automated execution of generated feature computation code while reducing risk of unauthorized system interaction, resource exhaustion, or unsafe execution behavior.

In some embodiments, runtime restrictions in the sandbox environment are applied independently of prompt-based restrictions and independently of pre-execution validation so that prohibited operations remain disabled even if generated code attempts to invoke them indirectly during execution.

In some embodiments, the system incorporates automated safeguards to improve robustness in the presence of imperfect real-world data. Such safeguards may include replacing null or missing values with defaults or sentinel values, rejecting or repairing code that references unavailable schema elements, coercing values to expected types where possible, inserting safe division logic, clipping or bounding out-of-range values, normalizing empty or malformed text inputs, parsing or correcting invalid date formats, and mapping deprecated or renamed columns to current schema versions.

In some embodiments, one or more safeguards are inserted automatically during a repair phase triggered by validation or execution errors. The repair phase may also insert transformations applied to one or more input columns to produce values having a distribution more suitable for downstream machine learning algorithms, including logarithmic, bounded, or scaled transformations.

If the code fails to run, the code and the error traceback are passed to a system which parses the code, reads the error message, and then sends the parsed code elements to a series of subroutines that may be able to fix the problem. For example, if a feature generates a division-by-zero error, this system identifies all examples of division in the feature code and adds an error-handling clause to cover cases where the denominator is zero. This does not fix all errors but it fixes most of them.

In addition to division-by-zero conditions, the automated repair process may address other execution or validation failures including missing-column errors, malformed function signatures, type-mismatch errors, null-handling errors, index errors, key-access errors, or other detectable failure modes.

In some embodiments, the system captures an error message or traceback, identifies one or more code locations associated with the failure, and generates a revised prompt or repair instruction for submission to a language model. Revised feature computation code returned by the language model may then be re-validated using the schema-consistency checks and, if appropriate, re-executed in the sandbox environment.

If repeated repair attempts fail, the feature may be archived together with one or more failure reasons and excluded from further execution.

In some embodiments, the system optionally prunes duplicate or near-duplicate candidate features before or after model training. Pruning may be based on semantic similarity of feature descriptions, structural similarity of normalized feature specifications, equivalence or similarity of generated feature computation code, or correlation analysis of computed feature values.

In some embodiments, duplicate or near-duplicate candidate feature concepts are rejected when a semantic similarity score relative to a previously accepted candidate feature concept satisfies or exceeds a predefined similarity threshold.

In some embodiments, human review is performed only after automated validation, execution, and optional predictive evaluation have been completed, thereby concentrating manual effort on features that have already been identified as viable or high impact. Human review may be applied selectively to a subset of stored features selected according to predictive score, deployment priority, or business relevance.

The result is a large number of coded, operational features that can then be tested through machine-learning or other statistical techniques for predictive power. Because the system is designed to be run in a fully automated manner, it can generate thousands of these relatively quickly and with reduced computing time and reduced manual effort. This enables a significantly faster and more effective feature-generation process.

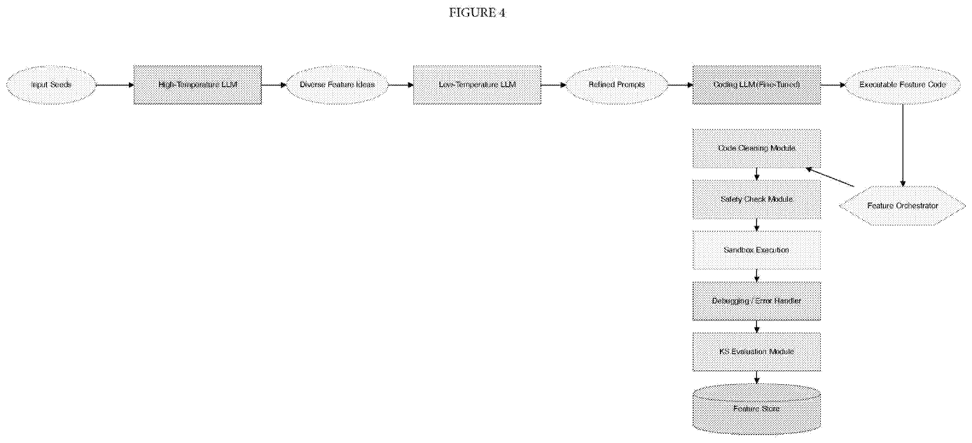

Reference is now made to FIGS. 4-6.

FIG. 4 is a block diagram illustrating the detailed interaction between the large language model (LLM) modules within the automated feature generation system. It shows the flow of data from the high-temperature LLM, which generates diverse feature ideas, to the low-temperature LLM, which refines these ideas into interpretable prompts, and finally to the fine-tuned coding LLM, which produces executable feature code. The diagram highlights the hierarchical structure and the transformation of ideas through each stage.

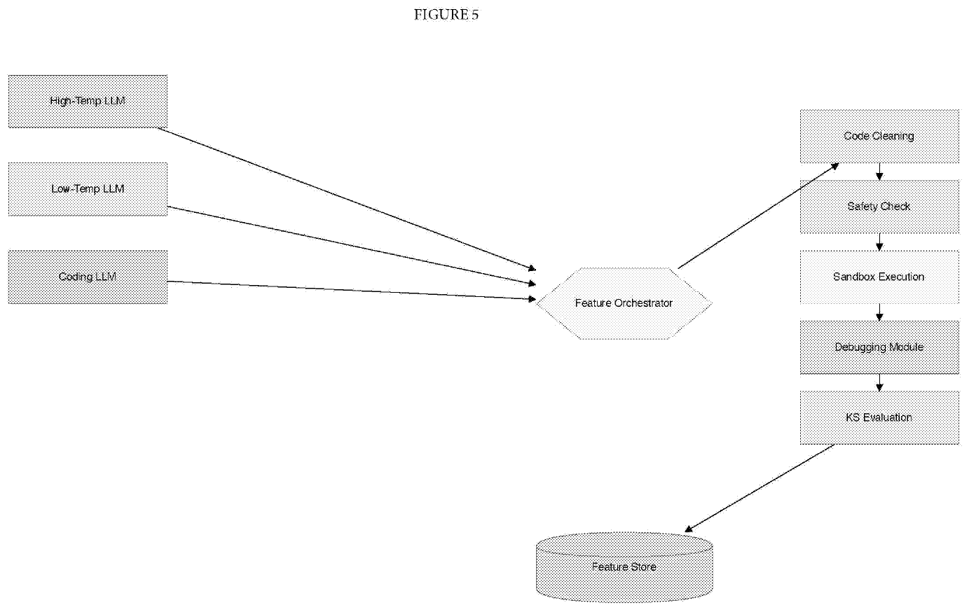

FIG. 5 is a diagram depicting the operations of the feature orchestrator and feature store within the system. It illustrates how the feature orchestrator manages the routing and retrieval of outputs from the LLM modules, ensuring seamless integration and storage of candidate features in the feature store. The figure also shows the association of evaluative metrics with each stored feature, facilitating efficient feature management and prioritization.

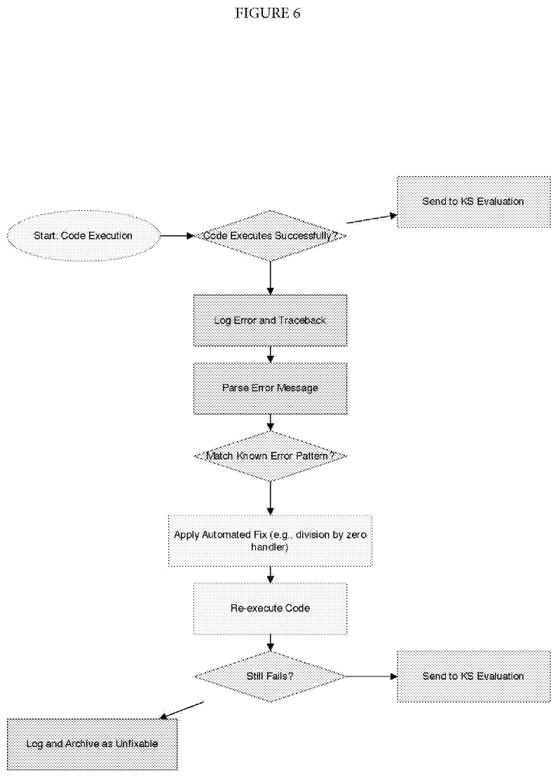

FIG. 6 is a flowchart detailing the iterative error handling and debugging process within the system. It outlines the steps taken when generated feature code fails to execute, including logging error messages, parsing errors, applying automated fixes, and re-executing the code. The flowchart also depicts the decision points for determining whether a feature can be corrected or should be archived as unfixable, ensuring robust error management and system reliability.

In some embodiments, the disclosed system includes a feature orchestrator and a feature store that cooperate to manage end-to-end automation of candidate feature generation, validation, execution, evaluation, and persistence. The feature orchestrator may route intermediate artifacts among language model modules, cleaning and validation subsystems, sandbox execution environments, and evaluation modules, and may control progression of each candidate feature through a defined processing lifecycle. In some embodiments, the feature orchestrator is implemented as a state-driven processing system configured to manage a lifecycle of each candidate feature. Each candidate feature may be represented as a structured object containing at least a feature identifier, a current processing state, an associated normalized feature specification, and references to generated code and evaluation data.

The orchestrator may maintain states including generated, normalized, code_generated, validated, executed, evaluated, stored, and archived. Transitions between states may be triggered by completion of processing steps or detection of one or more errors.

By way of example, upon receipt of generated feature computation code, the orchestrator may transition a feature object to a validation state in which schema-consistency checks are applied. If validation succeeds, the feature object proceeds to sandbox execution and then to evaluation. If validation fails, the feature object may be routed to repair, regeneration, or archival.

In some embodiments, the orchestrator manages message passing among language model modules, validation subsystems, sandbox execution environments, and evaluation modules using a queue-based architecture, an event-driven architecture, or another inter-process coordination mechanism.

The candidate features, before being stored in the feature store, are evaluated for safety, proper execution, expected results, and advantageously, predictive power.

In some embodiments, the feature store comprises a structured repository configured to persist feature records and associated evaluation records for generated features.

A feature record may include a unique feature identifier, a normalized feature specification, a code hash or serialized representation of feature computation code, a schema version identifier, one or more identifiers of language models used during generation, one or more seed values, and one or more timestamps associated with generation or validation.

An associated evaluation record may include a validation status indicator, an execution status indicator, one or more predictive evaluation metrics, a ranking or prioritization score, a retry count, and one or more error codes or failure reasons.

Storing feature records together with associated evaluation records and lifecycle information enables traceability, reproducibility, prioritization, and later re-use of generated features.

In some embodiments, a stored association between feature computation code and evaluation data includes a code identifier, a validation status code, an execution status code, and an error reason code, thereby enabling deterministic retrieval and prioritization of candidate features.

In some embodiments, the feature store further maintains lineage metadata linking a stored feature to an originating candidate feature concept, the corresponding normalized feature specification, one or more prompt identifiers associated with one or more language model stages, and one or more intermediate outputs generated during processing. Such lineage metadata enables reproducibility, downstream search, and analysis of feature generation pathways.

In some embodiments, retention of prompt identifiers, seed values, and model identifiers is optional rather than required for validation of predictive performance. However, retaining such metadata may improve search efficiency, reduce repeated exploration of previously tested ideas, and improve operation of the automated feature generation system over time.

In some embodiments, the disclosed system improves feature generation quality iteratively by generating candidate feature concepts, normalizing the candidate feature concepts into structured specifications, generating feature computation code, validating and optionally repairing the generated code, and retaining successful outputs for later reuse or prioritization. One or more of the language model stages may be fine-tuned or not fine-tuned, depending on the implementation.

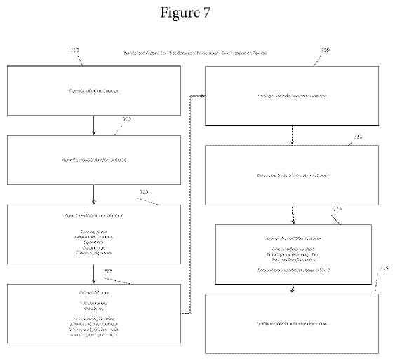

Reference is now made to FIG. 7 which illustrates generation of a normalized feature specification from a candidate feature concept and use of the normalized feature specification together with a dataset schema to drive feature computation code generation and high-level schema-aware validation before sandbox execution. As shown, the normalized feature specification acts as a structured control layer between natural-language idea generation and executable feature computation code.

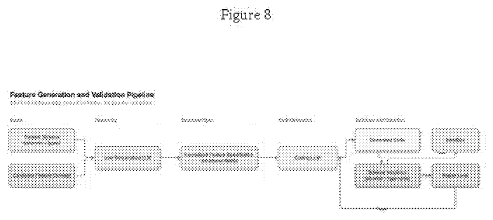

Reference is now made to FIG. 8 which illustrates a static validation pipeline for generated feature computation code. Generated code is parsed into an abstract syntax tree, identifiers are extracted, allowlist and type-rule checks are applied, prohibited constructs are detected, and a validation report is generated indicating pass or fail status and, in some embodiments, one or more associated reason codes. In some embodiments, the validation report indicates whether import resolution, dynamic code execution, file system access, or external network access is prohibited and whether such prohibitions are additionally enforced at runtime in the sandboxed execution environment.

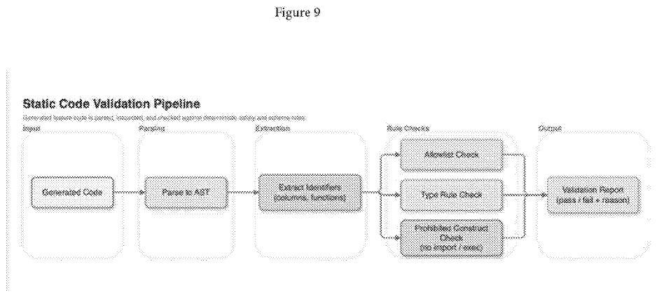

Reference is now made to FIG. 9 which illustrates persistent records for lifecycle tracking of generated features. As shown, feature metadata, evaluation metrics, and lifecycle progression may be stored together so that a generated feature can be reproduced, ranked, re-evaluated, or archived based on prior validation and execution outcomes.

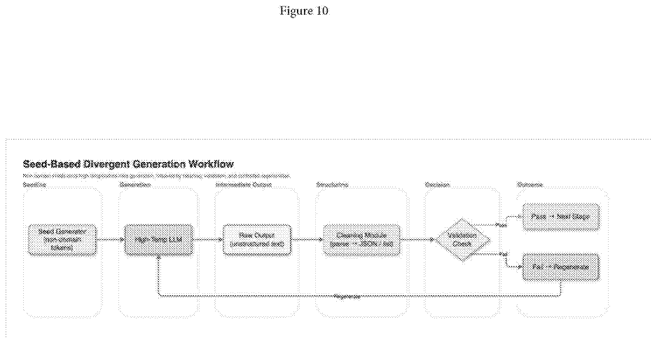

Reference is now made to FIG. 10 which illustrates a seed-based divergent generation workflow in which non-domain seeds are supplied to a language model operating at a comparatively high randomness setting, raw textual output is cleaned and converted into a structured representation, and the structured representation is validated before being passed to a subsequent processing stage. Outputs that fail validation may be logged and routed to regeneration.

Although the present disclosure has been described with reference to particular embodiments, examples, and implementations, those skilled in the art will appreciate that various modifications, substitutions, combinations, and alterations can be made. The disclosed embodiments are illustrative rather than limiting, and features described in connection with one embodiment may be combined with features of another embodiment unless expressly stated otherwise or unless such combination would be incompatible. In addition, the sequence of operations described herein may be varied, and certain acts may be performed concurrently, in a different order, or omitted, depending on the particular implementation.

1. A system for automated generation of features for a machine learning model, comprising:
one or more processors and a memory storing instructions that, when executed by the one or more processors, cause the system to:
(a) obtain a machine-readable schema of a training dataset, the schema identifying column names and corresponding data types;
(b) generate a plurality of candidate feature concepts by providing at least one first prompt to a first large language model operated at a first randomness setting, the at least one first prompt including at least one seed value that is not derived from the training dataset;
(c) generate a plurality of normalized feature specifications by providing at least one second prompt, derived from the plurality of candidate feature concepts, to a second large language model operated at a second randomness setting lower than the first randomness setting, each normalized feature specification including (i) a feature name, (ii) one or more referenced columns selected from the schema, (iii) an operation definition defining one or more computations to be performed using the referenced columns, and (iv) an output data type;
(d) for each normalized feature specification, generate feature computation code by providing at least one third prompt, including the schema and the normalized feature specification, to a third large language model that is fine-tuned on feature computation code, the feature computation code defining a feature computation function configured to compute a feature value for an input record; and
(e) prior to storing or executing the feature computation code, perform schema-aware validation of the feature computation code comprising:
(i) parsing the feature computation code into an abstract syntax tree;
(ii) extracting, from the abstract syntax tree, identifier references comprising referenced column names, function calls, and attribute accesses;
(iii) enforcing an identifier allowlist that includes at least (A) the one or more referenced columns identified in the normalized feature specification, (B) local variables defined within the feature computation code, and (C) functions in a predefined allowlist of permitted built-in functions;
(iv) verifying that each column usage is consistent with the corresponding data type in the schema by enforcing one or more type rules; and
(v) rejecting the feature computation code in response to detecting, in the abstract syntax tree, at least one prohibited construct comprising an import statement, a dynamic code execution instruction, a file system access instruction, or an external network access instruction.

2. A system for automated generation of features for a machine learning model, comprising:
a network interface;
one or more processors;
a memory storing instructions;
a feature store; and
a sandboxed execution environment,
wherein the one or more processors are configured to execute the instructions to cause the system to:
(a) obtain a machine-readable schema of a training dataset, the schema identifying at least column names and corresponding data types;
(b) obtain first large language model output generated at a first randomness setting by transmitting, via the network interface, at least one first prompt that includes at least one seed value that is not derived from the training dataset and by receiving, via the network interface, as the first large language model output, a plurality of candidate feature concepts expressed as natural language descriptions;
(c) obtain second large language model output generated at a second randomness setting lower than the first randomness setting by transmitting, via the network interface, at least one second prompt derived from the plurality of candidate feature concepts and by receiving, via the network interface, as the second large language model output, a plurality of normalized feature specifications;
(d) for each normalized feature specification, obtain third large language model output generated by a third large language model that is fine-tuned on feature computation code by transmitting, via the network interface, at least one third prompt that includes the schema and the normalized feature specification and by receiving, via the network interface, as the third large language model output, feature computation code for the normalized feature specification, the feature computation code defining a feature computation function having a prescribed function signature;
(e) validate the feature computation code prior to execution by applying at least one schema-consistency check comprising:
(i) parsing the feature computation code into an abstract syntax tree;
(ii) extracting identifier references from the abstract syntax tree;
(iii) enforcing an identifier allowlist derived from the normalized feature specification by permitting references to only (A) the one or more referenced columns identified in the normalized feature specification, (B) local variables defined within the feature computation code, and (C) functions in a predefined allowlist of permitted built-in functions;
(iv) verifying that each column usage is consistent with the corresponding data type in the schema by enforcing one or more type rules; and
(v) rejecting the feature computation code in response to detecting, in the abstract syntax tree, at least one prohibited construct comprising an import statement, a dynamic code execution instruction, a file system access instruction, or an external network access instruction;
(f) after validating the feature computation code, execute the feature computation function in the sandboxed execution environment, the sandboxed execution environment enforcing at least a time limit and a memory limit and being configured to disable at least (i) import resolution at runtime and (ii) file system and external network access at runtime; and
(g) store, in the feature store, an association between the feature computation code and at least one evaluation metric for prioritizing candidate features, the at least one evaluation metric including at least one of an execution status, a validation status, or a predictive value score computed on a labeled sample dataset.

3. The system of claim 2, wherein the first randomness setting corresponds to a first temperature parameter and the second randomness setting corresponds to a second temperature parameter that is lower than the first temperature parameter.

4. The system of claim 2, wherein the at least one seed value is generated by a seed generation routine that produces non-domain seed tokens not derived from the training dataset.

5. The system of claim 2, wherein the one or more processors are further configured to reject a candidate feature concept in response to a semantic similarity score between the candidate feature concept and a previously accepted candidate feature concept exceeding a similarity threshold.

6. The system of claim 2, wherein the prescribed function signature comprises an input parameter representing a single input record and an output comprising a single scalar feature value having a data type corresponding to the output data type identified in the normalized feature specification.

7. The system of claim 2, wherein enforcing the one or more type rules comprises rejecting the feature computation code in response to detecting (i) a numeric operation applied to a non-numeric column type, (ii) a date operation applied to a non-date column type, or (iii) a text operation applied to a non-text column type.

8. The system of claim 2, wherein the one or more processors are further configured to perform an error handling loop in response to a failure of the feature computation code during validation or execution, the error handling loop comprising capturing an error message, obtaining revised feature computation code by transmitting, via the network interface, at least a portion of the error message to at least one of the second large language model or the third large language model, and re-validating the revised feature computation code using the at least one schema-consistency check.

9. The system of claim 2, wherein the predictive value score comprises a Kolmogorov-Smirnov statistic computed on a labeled sample dataset, and wherein the one or more processors are further configured to retain or prioritize the feature computation code based on the Kolmogorov-Smirnov statistic satisfying a threshold criterion.

10. The system of claim 2, wherein the at least one evaluation metric further includes a code identifier comprising at least one of a code hash, a validation status code, an execution status code, or an error reason code.

11. A method for automated generation of features for a machine learning model, comprising:
(a) obtaining, by a computer system, a machine-readable schema of a training dataset, the schema identifying at least column names and corresponding data types;
(b) obtaining, by the computer system, first large language model output generated at a first randomness setting by transmitting at least one first prompt that includes at least one seed value not derived from the training dataset and receiving, as the first large language model output, a plurality of candidate feature concepts expressed as natural language descriptions;
(c) obtaining, by the computer system, second large language model output generated at a second randomness setting lower than the first randomness setting by transmitting at least one second prompt derived from the plurality of candidate feature concepts and receiving, as the second large language model output, a plurality of normalized feature specifications;
(d) for each normalized feature specification, obtaining, by the computer system, third large language model output generated by a third large language model that is fine-tuned on feature computation code by transmitting at least one third prompt that includes the schema and the normalized feature specification and receiving, as the third large language model output, feature computation code for the normalized feature specification, the feature computation code defining a feature computation function having a prescribed function signature for computing a feature value from an input record; and
(e) validating, by the computer system, the feature computation code prior to storage or execution by applying at least one schema-consistency check comprising:
(i) parsing the feature computation code into an abstract syntax tree;
(ii) extracting identifier references from the abstract syntax tree;
(iii) enforcing an identifier allowlist derived from the normalized feature specification by permitting references to only (A) the one or more referenced columns identified in the normalized feature specification, (B) local variables defined within the feature computation code, and (C) functions in a predefined allowlist of permitted built-in functions;
(iv) verifying that each column usage is consistent with the corresponding data type in the schema by enforcing one or more type rules; and
(v) rejecting the feature computation code in response to detecting, in the abstract syntax tree, at least one prohibited construct comprising an import statement, a dynamic code execution instruction, a file system access instruction, or an external network access instruction; and
(f) after validating the feature computation code, executing, by the computer system, the feature computation function in a sandboxed execution environment that enforces at least a time limit and a memory limit and that is configured to disable at least (i) import resolution at runtime and (ii) file system and external network access at runtime.

12. The method of claim 11, wherein the first randomness setting corresponds to a first temperature parameter and the second randomness setting corresponds to a second temperature parameter that is lower than the first temperature parameter.

13. The method of claim 11, wherein the at least one seed value is generated by a seed generation routine that produces non-domain seed tokens not derived from the training dataset.

14. The method of claim 11, further comprising rejecting a candidate feature concept in response to a semantic similarity score between the candidate feature concept and a previously accepted candidate feature concept exceeding a similarity threshold.

15. The method of claim 11, wherein validating the feature computation code comprises parsing an abstract syntax tree of the feature computation code and enforcing a rule that disallows any reference to an identifier not present in (i) the schema, (ii) a predefined allowlist of functions, or (iii) variables defined within the feature computation code.

16. The method of claim 11, wherein each normalized feature specification further comprises a prescribed function signature, and wherein validating the feature computation code comprises verifying conformance to the prescribed function signature.

17. The method of claim 11, further comprising, in response to a failure of the feature computation code during validation or execution, performing an error handling loop comprising capturing an error message, obtaining revised feature computation code by transmitting at least a portion of the error message to at least one of the second large language model or the third large language model, and re-validating the revised feature computation code using the at least one schema-consistency check.

18. The method of claim 11, wherein the sandboxed execution environment further enforces at least one of a maximum recursion depth, a maximum number of executed instructions, or operating system syscall filtering for blocking file system and network operations.

19. The method of claim 11, further comprising computing, for at least one generated feature, a Kolmogorov-Smirnov statistic on a labeled sample dataset and retaining or prioritizing the at least one generated feature based on the Kolmogorov-Smirnov statistic satisfying a threshold criterion.
